(19) United States
(12) Patent Application Publication
(10) Pub. No.: US 2023/0289563 A1
(43) Pub. Date: Sep. 14, 2023

(54) MULTI-NODE NEURAL NETWORK CONSTRUCTED FROM PRE-TRAINED SMALL NETWORKS

(71) Applicant: Huawei Technologies Co., Ltd., Shenzhen (CN)

(72) Inventors: Jian Li, Waltham, MA (US); Han Su, Ann Arbor, MI (US)

(73) Assignee: Huawei Technologies Co., Ltd., Shenzhen (CN)

(21) Appl. No.: 18/320,007

(22) Filed: May 18, 2023

Related U.S. Application Data
(63) Continuation of application No. PCT/US2021/019097, filed on Feb. 22, 2021.

(51) Int. Cl. G06N 3/045

(52) U.S. Cl. CPC G06N 3/045

(57) ABSTRACT

A method of training a large neural network using a number of pre-trained smaller neural networks. Multiple pre-existing, pre-trained neural networks are used to create the large neural network using multi-level superposition. The pre-trained neural networks, each having a first number of multi-dimensional nodes, are each up-scaled to provide larger, sparse neural networks. The values of the larger, sparse neural networks are superpositioned into the larger neural network. The pre-trained neural networks may be created from publicly available, pre-trained neural networks. The larger neural network can be adapted for use in a different task by replacing and/or re-training one of the sub-networks used to create the large neural network.

### CLAIM OF PRIORITY

This application is a continuation of, and claims priority to, PCT Patent Application No. PCT/US2021/019097, entitled “MULTI-NODE NEURAL NETWORK CONSTRUCTED FROM PRE-TRAINED SMALL NETWORKS”, filed Feb. 22, 2021, which application is incorporated by reference herein in its entirety.

### FIELD

The disclosure generally relates to the field of artificial intelligence, and in particular, training neural networks.

### BACKGROUND

Artificial neural networks are finding increasing usage in artificial intelligence and machine learning applications. In an artificial neural network, a set of inputs is propagated through one or more intermediate, or hidden, layers to generate an output. The layers connecting the input to the output are connected by sets of weights that are generated in a training or learning phase by determining a set of a mathematical manipulations to turn the input into the output, moving through the layers calculating the probability of each output. Once the weights are established, they can be used in the inference phase to determine the output from a set of inputs.

Development of neural networks has focused on increasing capacity. The capacity of a neural network to absorb information is limited by its number of parameters. Much of the success of neural networks has come from building larger and larger neural networks. While such networks may perform better on various tasks, their size makes them more expensive to use. Larger networks take more storage space, making them harder to distribute, and take more time to run thereby requiring more expensive hardware. This is especially a concern if you are productionizing a model for a real-world application.

### SUMMARY

One general aspect includes a computer implemented method of training a neural network may include a number nodes. The computer implemented method includes instantiating a first plurality of pre-trained neural sub-networks each having a first number of multi-dimensional nodes, at least some of the multi-dimensional nodes having non-zero weights. The computer implemented method also includes up-scaling ones of the first plurality of pre-trained neural sub-networks to have a second, larger number of multi-dimensional nodes such that ones of the first plurality of pre-trained neural sub-networks have a sparse number of non-zero weights associated with the second, larger number of multi-dimensional nodes. The computer implemented method also includes creating the neural network by superpositioning non-zero weights of the plurality of pre-trained neural sub-networks by representing the non-zero weights in multi-dimensional nodes of the neural network. The computer implemented method also includes receiving data for a first task for computation by the neural network. The computer implemented method also includes executing the first task to generate a solution to the first task from the neural network.

Implementations may include any one or more of the foregoing methods further including creating the neural network further may include: creating a second plurality of neural sub-networks having the second, larger number of multi-dimensional nodes by superpositioning non-zero weights of the first plurality of neural sub-networks; and creating the neural network having multi-dimensional nodes by superpositioning non-zero weights of the second plurality of neural sub-networks into nodes of the neural network. Implementations may include any one or more of the foregoing methods further including connecting each of the first plurality of neural sub-networks such that each of the first plurality of pre-trained neural sub-networks is connected to selective nodes of another of the first plurality of networks, the selective nodes being less than all of the plurality of nodes of the another of the first plurality of networks arranged in a first level of neural sub-networks may include a sub-set of the first plurality of sub-networks. Implementations may include any one or more of the foregoing methods further including connecting each of the sub-set of the first plurality of neural sub-networks in the first level to selective ones of nodes of the second plurality of neural sub-networks a second level of neural sub-networks may include a sub-set of the first level. Implementations may include any one or more of the foregoing methods further including re-training the neural network for a new task by replacing at least a subset of the first plurality of neural sub-networks for the new task. Implementations may include any one or more of the foregoing methods wherein re-training further includes re-training the neural network for the new task by: calculating correlation parameters between the trained first plurality of neural sub-networks, predicting an empirical distribution of labels in training data of a new task based on the first task, training each of the first plurality of networks with the training data of the new task, and replacing ones of the first plurality of neural sub-networks with re-trained neural sub-networks. Implementations may include any one or more of the foregoing methods wherein replacing a neural sub-network may include replacing ones of the first plurality of neural sub-networks when there are more than a maximum number of pre-trained neural sub-networks. Implementations may include any one or more of the foregoing methods wherein replacing a neural sub-network may include replacing neural sub-networks having mediocre performance as determined relative to training data for the new task. Implementations of the described techniques may include hardware, a method or process, or computer software on a computer-accessible medium.

Another general aspect includes a processing device. The processing device includes a non-transitory memory storage which may include instructions. The processing device also includes one or more processors in communication with the memory, where the one or more processors create a neural network by executing the instructions to: instantiate at least a first plurality of pre-trained neural sub-networks, each having a first number of multi-dimensional nodes, at least some of the multi-dimensional nodes having non-zero weights; up-scale each of the first plurality of pre-trained neural sub-networks to have a second, larger number of multi-dimensional nodes such that ones of the first plurality of pre-trained neural sub-networks have a sparse number of non-zero weights associated with the second, larger number of multi-dimensional nodes; and create the neural network by superpositioning non-zero weights of the first plurality of neural sub-networks by representing the non-zero weights in multi-dimensional nodes of the neural network. Other embodiments of this aspect include corresponding computer systems, apparatus, and computer programs recorded on one or more computer storage devices, each configured to perform the actions of the instructions.

Implementations may include a processing device including any one or more of the foregoing features where the processors execute instructions to re-train the neural network for a new task by replacing at least a subset of the first plurality of neural sub-networks for the new task. Implementations may include a processing device including any one or more of the foregoing features where the re-training further includes re-training the neural network for the new task by executing instructions to: calculate correlation parameters between the trained first plurality of neural sub-networks, predict an empirical distribution of labels in training data of a new task based on the new task, train each of the first plurality of networks with the training data of the new task, and replace ones of the first plurality of neural sub-networks with re-trained neural sub-networks. Implementations may include a processing device including any one or more of the foregoing features where the replacing may include replacing ones of the first plurality of neural sub-networks when there are more than a maximum number of pre-trained neural sub-networks. Implementations may include a processing device including any one or more of the foregoing features where the replacing at least a subset of the first plurality of neural sub-networks for the new task may include replacing neural sub-networks having mediocre performance as determined relative to training data for the new task. Implementations may include a processing device including any one or more of the foregoing features where the processors execute instructions to create a second plurality of neural sub-networks having a second, larger number of multi-dimensional nodes by superpositioning non-zero weights of the first plurality of neural sub-networks; and connect each of the first plurality of neural sub-networks such that each of the first plurality and the second plurality of neural sub-networks is connected to selective nodes of another of the first plurality of neural sub-networks, the selective nodes being less than all of the nodes of the another of the plurality of neural sub-networks such that multiple ones of the plurality of neural sub-networks are arranged in a level of neural sub-networks, the connected selective ones creating at least two levels of recursive connections of the first plurality of neural sub-networks.

One general aspect includes a non-transitory computer-readable medium storing computer instructions to train a neural network by training a plurality of neural sub-networks each having a first number of multi-dimensional nodes. The instructions cause the one or more processors to perform the training by: instantiating a first plurality of pre-trained neural sub-networks, each having a first number of multi-dimensional nodes, at least some of the multi-dimensional nodes having non-zero weights; up-scaling ones of the first plurality of pre-trained neural sub-networks to have a second, larger number of multi-dimensional nodes such that each of the first plurality of pre-trained neural sub-networks have a sparse number of non-zero weights associated with the second, larger number of multi-dimensional nodes; creating a second plurality of neural sub-networks having the second, larger number of multi-dimensional nodes by superpositioning non-zero weights of the first plurality of neural sub-networks in the second plurality of neural sub-networks; up-scaling ones of the second plurality of neural sub-networks to have a third number of multi-dimensional nodes such that ones of the second plurality of sub-networks have a sparse number of non-zero weights associated with the third number of multi-dimensional nodes; and creating the neural network by superpositioning non-zero weights in multi-dimensional nodes of the neural network ones of the third plurality of networks. The instructions also cause the one or more processors to receive data for a first task for computation by the neural network. cause the one or more processors to compute the task data to generate a solution to the first task from the neural network.

The non-transitory computer-readable medium may include any of the foregoing features and further include the processors executing instructions to re-train the neural network for a new task by replacing at least a subset of the first plurality of neural sub-networks for the new task. The non-transitory computer-readable medium may include any of the foregoing features and further include the processors executing instructions to re-train the neural network for the new task by executing instructions to: calculate correlation parameters between the trained first plurality of neural sub-networks, predict an empirical distribution of labels in training data of a new task based on the first task, train each of the first plurality of networks with the training data of the new task, and replace ones of the first plurality of neural sub-networks with re-trained neural sub-networks. The non-transitory computer-readable medium may include any of the foregoing features and further include the processors executing instructions to replace ones of the first plurality of neural sub-networks when there are more than a maximum number of pre-trained neural sub-networks. The non-transitory computer-readable medium may include any of the foregoing features and further include the processors executing instructions to replace neural sub-networks having mediocre performance as determined relative to training data for the new task. The non-transitory computer-readable medium may include any of the foregoing features and further include the processors executing instructions to: connect each of the first plurality of neural sub-networks such that each of the first plurality and the second plurality of neural sub-networks is connected to selective nodes of another of the first and second plurality of neural sub-networks, the selective nodes being less than all of the nodes of the first and second plurality of networks, such that multiple ones of the first and second plurality of neural sub-networks are arranged in a level of neural sub-networks, the connecting creating at least two levels of recursive connections of the first and second plurality of neural sub-networks.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate the same or similar elements.

FIG. 1 is a method illustrating a prior art process for training a large neural network

FIG. 2 is a flowchart representing an overview of a method for performing the described subject matter.

FIG. 3 is a high-level block diagram of the multi-level nesting and superposition of sub-networks to crates a large neural network.

FIG. 4 graphically illustrates connections between individual neural network nodes and supernodes.

FIG. 5 is a flowchart illustrating the respective steps performed at step 225 in FIG. 2.

FIG. 6 is a flowchart illustrating updating one or more subnetworks.

FIG. 7 is a block diagram of a processing device that can be used to implement various embodiments.

### DETAILED DESCRIPTION

The present disclosure and embodiments address a novel method of training a large neural network using a number of pre-trained smaller neural networks. The pre-trained smaller neural networks may be considered sub-networks of the larger neural network. The present technology provides a neural network of a large size, defined by a network designer, which reuses multiple pre-existing, pre-trained smaller neural networks to create the large neural network using multi-level superposition. Each of the pre-trained neural networks is up-scaled and results in a larger, sparse neural network, the values in which are superpositioned into the larger neural network for the defined task. The pre-trained neural networks may be created from existing available neural networks which have been trained using labeled training data associated with the particular task. Once up-scaled, one determines, for each of the pre-trained neural networks, nodes in the first pre-trained networks having sparse values. This allows creation of a neural network having a larger number of multi-dimensional nodes by superpositioning non-zero weights of the up-scaled pre-trained neural networks into the larger network. The larger neural network can be adapted for use in a different task by replacing and/or re-training one of the sub-networks used to create the large neural network.

Neural networks may take many different forms based on the type of operations performed within the network. Neural networks are formed of an input and an output layer, with a number of intermediate hidden layers. Most neural networks perform mathematical operations on input data through a series of computational (hidden) layers having a plurality of computing nodes, each node being trained using training data.

Each node in a neural network computes an output value by applying a specific function to the input values coming from the previous layer. The function that is applied to the input values is determined by a vector of weights and a bias. Learning, in a neural network, progresses by making iterative adjustments to these biases and weights. The vector of weights and the bias are called filters and represent particular features of the input (e.g., a particular shape).

Layers of the artificial neural network can be represented as an interconnected group of nodes or artificial neurons, represented by circles, and a set of connections from the output of one artificial neuron to the input of another. The nodes, or artificial neurons/synapses, of the artificial neural network are implemented by a processing system as a mathematical function that receives one or more inputs and sums them to produce an output. Usually each input is separately weighted and the sum is passed through the node's mathematical function to provide the node's output. Nodes and their connections typically have a weight that adjusts as a learning process proceeds. Typically, the nodes are aggregated into layers. Different layers may perform different kinds of transformations on their inputs. Signals travel from the first layer (the input layer), to the last layer (the output layer), possibly after traversing the layers multiple times.

An artificial neural network is “trained” by supplying inputs and then checking and correcting the outputs. For example, a neural network that is trained to recognize dog breeds will process a set of images and calculate the probability that the dog in an image is a certain breed. A user can review the results and select which probabilities the neural network should display (above a certain threshold, etc.) and return the proposed label. Each mathematical manipulation as such is considered a layer, and complex neural networks have many layers. Due to the depth provided by a large number of intermediate or hidden layers, neural networks can model complex non-linear relationships as they are trained.

There are a number of publicly available pre-trained neural networks which are freely available to download and use. Each of these pre-trained neural networks may be operable on a processing device and has been trained to perform a particular task. For example, a number of pre-trained networks such as GoogLeNet and Squeezenet have been trained on the ImageNet (www.image-net.org) dataset. These are only two examples of pre-trained networks and it should be understood that there are networks available for tasks other than image recognition which are trained on datasets other than ImageNet.

In accordance with the present technology, pre-trained networks having a limited number of nodes are used as the building block for creating a large, trained neural network.

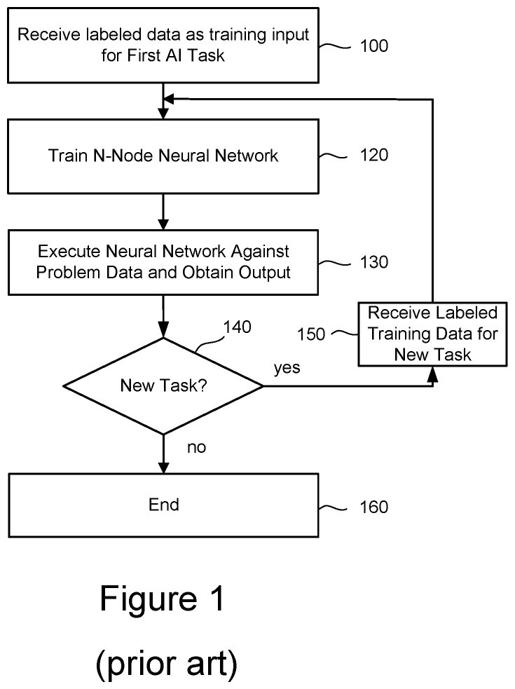

FIG. 1 is a flowchart describing one embodiment of a process for training a conventional neural network to generate a set of weights. The training process may be performed by one or more processing devices, including cloud-based processing devices, allowing additional or more powerful processing to be accessed. At step 100, the training input, such as a set of images in the above example, is received (e.g., the image input in FIG. 1). The training input may be adapted for a first network task—such as the example above of identifying dog breeds. At step 120 the input is propagated through the layers connecting the input to the next layers a current filter or set of weights. For example, each layer's output may be then received at a next layer so that the values received as output from one layer serve as the input to the next layer. The inputs from the first layer are propagated in this way through all of the intermediate or hidden layers until they reach the network output. Once trained, the neural network can take test data and provide an output at 130. In the dog breed example of the preceding paragraph, the input would be the image data of a number of dogs, and the intermediate layers use the current weight values to calculate the probability that the dog in an image is a certain breed, with the proposed dog breed label returned at step 130. A user can then review the results for accuracy so that the trainings system can select which probabilities the neural network should return and decide whether the current set of weights supply a sufficiently accurate labelling and, if so, the training is complete. If the result is not sufficiently accurate, the network can be retrained by repeating steps 100, 120. However, if a different network task is desired at 140, a new set of training data must be provided at 150 and the training process repeated for the new training data at 120. The new problem data can then be fed to the network for an output to the new task at 130 again. When there are no new tasks, the training process concludes at 160.

Neural networks are typically feedforward networks in which data flows from the input layer, through the intermediate layers, and to the output layer without looping back. At first, in the training phase of supervised learning as illustrated by FIG. 1, the neural network creates a map of virtual neurons and assigns random numerical values, or “weights”, to connections between them. The weights and inputs are multiplied and return an output. If the network does not accurately recognize a particular pattern, an algorithm adjusts the weights. That way the algorithm can make certain parameters more influential (by increasing the corresponding weight) or less influential (by decreasing the weight) and adjust the weights accordingly until it determines a set of weights that provide a sufficiently correct mathematical manipulation to fully process the data.

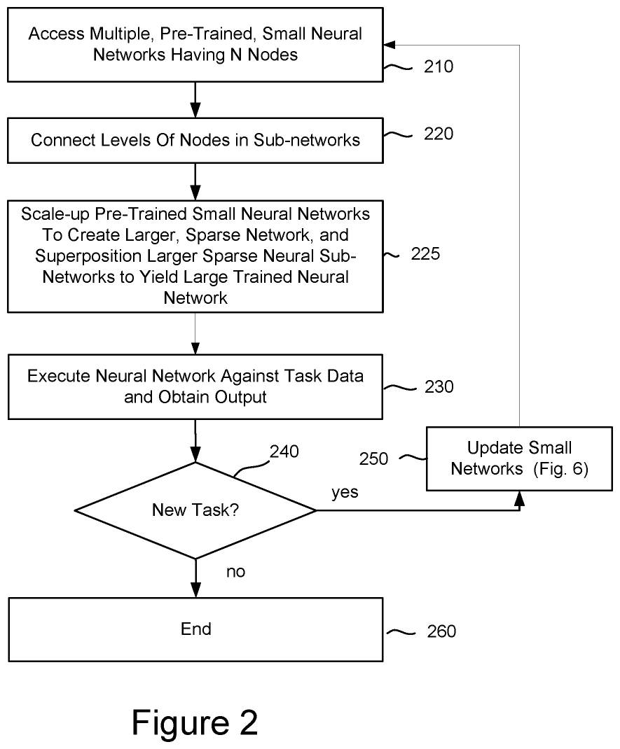

FIG. 2 is a flowchart describing one embodiment of a process for training a neural network in accordance with the present technology. At step 210, rather than training a single, large neural network with training data, pre-trained neural networks are accessed and utilized. Generally, such pre-trained neural networks are publicly available and have used training data input for a particular task. Such pre-trained networks are smaller and generally more focused on a particular task than large-scale trainable networks. As used herein, pre-trained neural networks have a number of nodes (N) which are only a fraction of the number of nodes (M) which a user of the present technology may create in a large neural network.

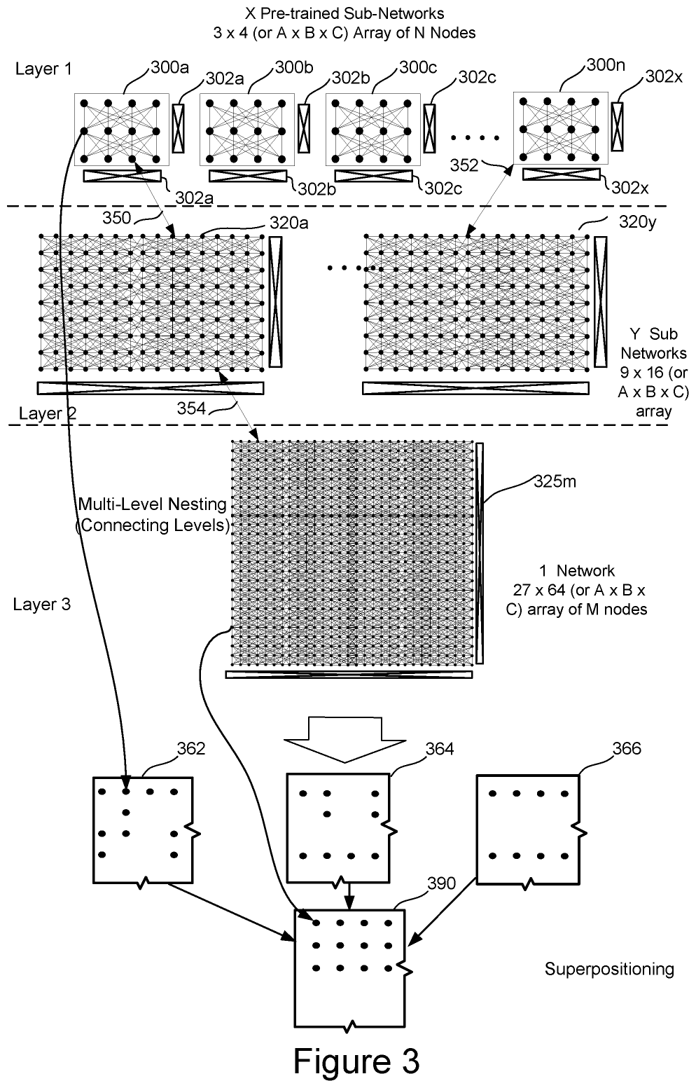

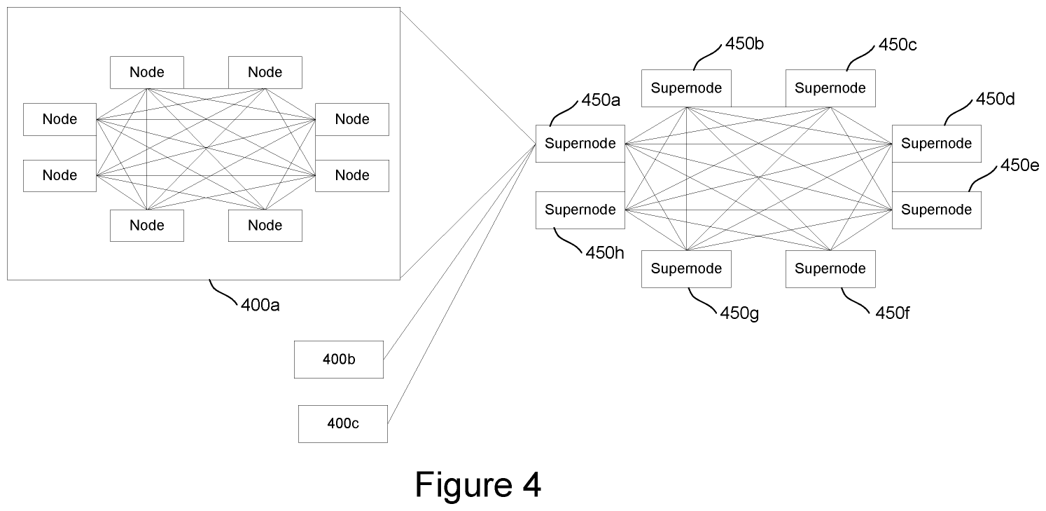

In the large neural network, each pre-trained neural network of N nodes can be considered as one of a plurality (e.g. a “first” plurality) of sub-networks nested at multiple levels in the large network. In embodiments of the technology, “N” may be on the order of hundreds or thousands of nodes. In a further aspect, at step 220, nodes at different levels of each of the pre-trained networks (and sub-networks created from the pre-trained networks) can be selectively connected to other nodes at different levels to reduce the number of direct connections between nodes at different levels. In one embodiment, step 220 is optional and need not be performed. This multi-level nesting is further described below with respect to FIGS. 3 and 4.

A sparse neural network can be considered a matrix with a large percentage of zero values in the weighting of the network node; conversely, a dense network has many non-zero weights. At step 225, for a given size of a desired large neural network of M nodes, each of the pre-trained neural networks may be up-scaled to the size of large neural network, thereby creating a second plurality of neural networks. In embodiments of the technology, “M” may be on the order of millions or billions of nodes. Generally, this second plurality of neural networks will comprise sparse networks (even in cases where the pre-trained network which has been up-scaled was dense). That is, for each pre-trained network having N nodes which can be conceptually recognized as a two- or three-dimensional matrix of computing nodes, and for a given desired neural network having M nodes (also configured as a two- or three-dimensional matrix of computing nodes), each pre-trained network may be “scaled up” to the number of nodes M and matrix scale of the large network. In up-scaling the smaller network, each up-scaled pre-trained neural network will now comprise a sparse neural network. Because the up-scaled pre-trained networks are sparse, superpositioning can be used to combine the up-scaled pre-trained networks into the desired large neural network.

Using the image recognition example, the multiple pre-trained neural networks gathered at step 210 may be up-scaled and thereafter superpositioned into a large neural network having M nodes, with the large network having trained weights which may be used to solve a given image recognition problem (for example, dog breed identification).

Once trained, the neural network can take task data and provide an output at 230. In the dog breed example of the preceding paragraph, the input would be the image data of a number of dogs, and the intermediate layers use the weight values to calculate the probability that the dog in an image is a certain breed, with the proposed dog breed label returned at step 230. A user can then review the results for accuracy so that the trainings system can select which probabilities the neural network should return and decide whether the current set of weights supply a sufficiently accurate labelling and, if so, the training is complete.

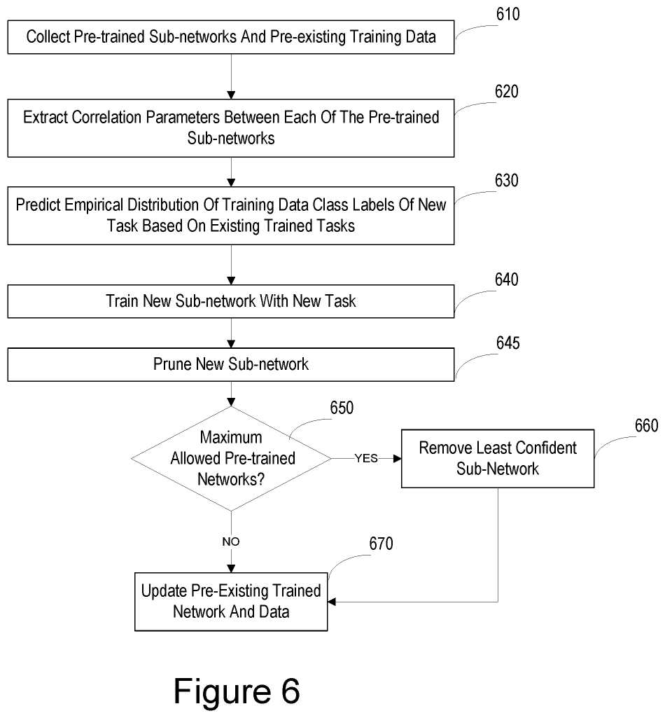

When a new task is presented at 240, the neural network training may be updated by updating one or more of the smaller size (N-node) networks, as described below with respect to FIG. 6.

FIG. 3 is a high-level block diagram graphically illustrating multi-level nesting and superposition of sub-networks to create a trained large neural network. As previously noted, neural networks are generally comprised of multiple layers of nodes including an input layer, an output layer and one or more hidden layers. Nodes in the layers are connected to form a network of interconnected nodes. The connections between these nodes act to enable signals to be transmitted from one node to another. As the number of layers within a neural network increases, interconnecting each node in a layer to each node in other layers can be problematic, and can impede network performance and increase complexity. As discussed above at step 220, selectively connecting different layers of networks provides a multi-level nesting of networks which improves efficiency of the present technology. The process of step 220 will be described with respect to FIG. 3.

FIG. 3 illustrates three-layers of nodes (Layer 1, Layer 2 and Layer 3), each having multiple neural networks which are “nested” in succeeding levels. FIG. 3 illustrates a plurality (“X”) of pre-trained networks 300a-300x having N nodes and conceptually provided at a first level of the multi-level nesting of sub-networks—“layer 1”. Pre-trained networks 300a-300x may be considered as a matrix having two dimensions (A×B) or three dimensions (A×B×C). In one embodiment, each node in each pre-trained matrix 300a-300x may be coupled to each other node in each matrix. For simplicity, each pre-trained matrix 300a-300x is illustrated as a two dimensional, 3×4 matrix. A first multi-level nesting results in “Y” subnetworks (320a . . . 302y) having, in this example, 9×16 nodes, and a third level neural network 325m of 27×64 nodes (i.e. “M” nodes in this example). It should be recognized that the array shown at 325m is illustrative only.

In some neural networks, each node in the network may be connected to each other node in the network, irrespective of any level at which the node operates. In accordance with the present technology, multi-level nesting comprises selectively connecting nodes of each smaller sub-network (including the pre-trained networks at Level 1) to a node in a sub-network at a different level. As such, for example, network 300a has a connection 350 to one representative node in network 320a of layer 2 and network 300n has a connection 352 to one representative node in network 320y of layer 2. Similarly, network 320a has a connection 354 to a representative node in network 325m of layer 3.

This is graphically illustrated in FIG. 4, which shows a 2×2 pre-trained network 400a wherein each node is connected to each other node in the network 400a, with one node in the pre-trained network coupled to a super-node 450a. Each supernode may have one or more pretrained networks 400 connected thereto. It should be understood that each of the supernodes 450a-450h may have one or more pre-trained networks selectively connected thereto.

Returning to FIG. 3, control of connections for each pre-trained network may be implemented by virtual cross-bar switches 302a-302x. Each subnet is therefore connected by hierarchical crossbar switches (or other interconnect topology) to form connections within the larger network by levels. As such, weights, neurons, filters, channels, magnitudes, gradients, and activations are controlled by the switch functions.

Generally, the internal connections of a virtual crossbar switch may be set to be selectively on or off to represent a pruned network (a small network that performs as good as a large one for one type of task), where the same connection may be off or on for another pruned network. In FIG. 3, the weights of best-effort pruned networks are superpositioned by the similarity of their weight distribution. In a basic example, where each weight is represented by a 4-bit binary value, the probability of overlapping weight distribution between small subnets out of 175 billion parameters is high. Consider that 175 billon divided by 24 values in a 1000×1000 matrix yields approximately 2.7K matches.

It should be recognized that the multilevel nesting techniques described above need not be utilized in every embodiment of the technology described herein. In alternative embodiments, all nodes at each level are connected to each other and in further embodiments, nodes across all levels are connected.

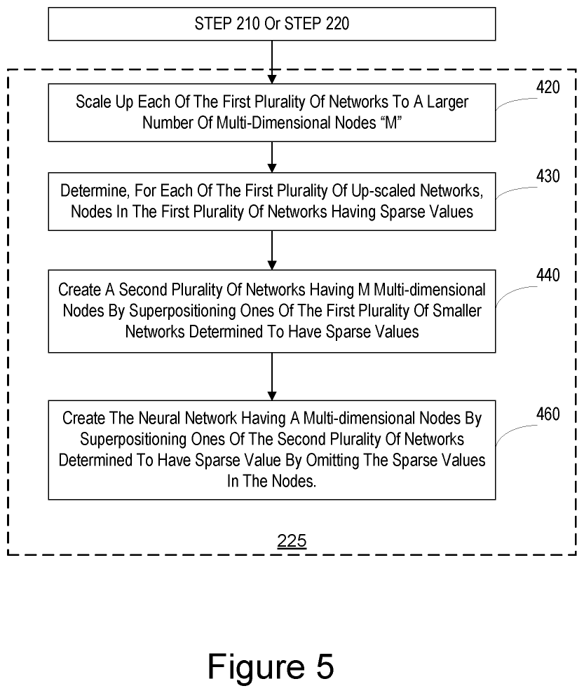

In another aspect of the technology, superpositioning of up-scaled pre-trained networks is used to create a large and dense trained neural network. FIG. 5 illustrates one embodiment of step 220 in FIG. 2. FIG. 5 will be described with reference to the lower half of FIG. 3. As illustrated in FIG. 5, step 225 may occur directly after step 210 or after step 220. Initially, at step 420, each of the first plurality of pre-trained subnetworks is a scaled up to a larger size network (i.e. M nodes)—the number of nodes desired in the large neural network. Scaling of each pre-trained neural network may include scaling in the same dimensions as the desired large network of M nodes or any other suitable dimensions. Once scaled to a larger size, each of the plurality of small, pre-trained networks will comprise sparsely populated sub-networks. At step 430, the method determines, for each of the upscaled networks, nodes in the upscaled networks which have values and those which do not. At 440, the method creates a second plurality of networks having M multidimensional nodes by superpositioning ones of the first plurality of populated nodes into nodes of the larger network. Finally, at 460, the neural network having M multidimensional nodes is created by superposition ones of the second plurality of networks determined to have weight values by positioning the weight values in the nodes in the larger network.

This process is illustrated graphically in FIG. 3 by connections 502, 504, and 506 which illustrate individual scaled nodes being positioned into the larger scaled networks 362, 364, 366 which result in the M node network 390. It should be understood that the number of nodes illustrated in FIG. 3 is only a 4×4 network, but the scaling factor for each of the pre-trained subnetworks could be much larger and the ultimate M node network even larger still. (In FIG. 3, only a small portion of networks 362, 364, 366 and 390 are illustrated and it will be understood that network 390 may have the same number of M nodes as network 325m in this example.)

As noted in FIG. 2, once a large neural network is created, a new task may be presented requiring modification or re-training of the large neural network. FIG. 6 illustrates one embodiment of step 250 of FIG. 2 for updating the neural network. Initially, at 610, the method collects the pre-trained subnetworks and pre-existing training data for the new task. This training data includes labeled data that have been tagged with one or more labels identifying certain properties or characteristics, or classifications or contained objects. At step 620, correlation parameters between each of the pre-trained subnetworks and the pre-existing training data are determined. This allows one to determine the performance of the pre-trained networks on the new task is good, bad or mediocre. In one embodiment, a maximal correlation algorithm may be used to determine the correlation parameters between the existing pre-trained networks and the new task training data. At 630, the method predicts an empirical distribution of training data class labels of the new past based on the existing trained tasks. This correlation prediction will be used to select pre-trained networks if the number of pre-trained networks exceeds a specified maximum. At 640, if necessary, one or more new sub-networks is trained with the new task training data and at 645, the newly trained sub-network(s) is pruned. At 640, training may be needed if one or more of the pre-trained networks exhibits mediocre performance characteristics. In this context, mediocre performance is determined as a network which is neither an excellent at the task nor poor at the task. At 645, pruning is a method of compression that involves removing unnecessary weights or nodes from a trained network. At 650, a determination is made as to whether or not the newly trained sub-network can be added to the pre-trained networks which can be used to build newly trained M node network for the new task. This determination is based on a specification of a network designer having decided upon a maximum number of pre-trained networks based on any number of given factors including network performance, processing power, and other constraints. If the maximum allowed pre-trained networks are not reached at 650, then at 670, the plurality of pre-trained networks can be updated using the newly trained network. If the maximum allowed pre-trained networks has been reached, then at 660, the method removes one or more mediocre performing networks. In this context, mediocre performing networks are those which, based on their performance of their pre-trained task, are neither very good nor very bad.

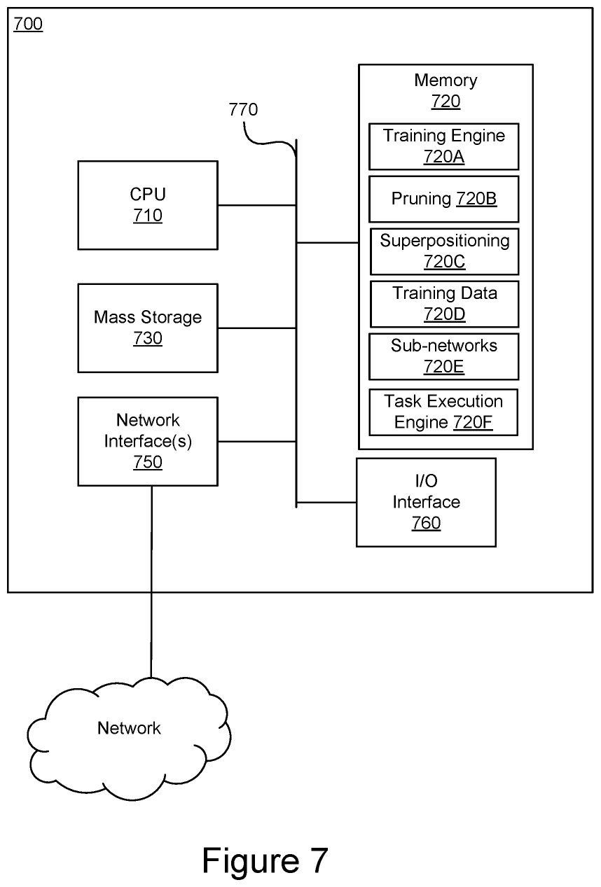

FIG. 7 is a block diagram of a network device 700 that can be used to implement various embodiments. Specific network devices may utilize all of the components shown, or only a subset of the components, and levels of integration may vary from device to device. Furthermore, the network device 700 may contain multiple instances of a component, such as multiple processing units, processors, memories, transmitters, receivers, etc. The network device 700 may include a central processing unit (CPU) 710, a memory 720, a mass storage device 730, I/O interface 760, and a network interface 750 connected to a bus 770. The bus 770 may be one or more of any type of several bus architectures including a memory bus or memory controller, a peripheral bus or the like.

The CPU 710 may comprise any type of electronic data processor. The memory 720 may comprise any type of system memory such as static random-access memory (SRAM), dynamic random-access memory (DRAM), synchronous DRAM (SDRAM), read-only memory (ROM), a combination thereof, or the like. In an embodiment, the memory 720 may include ROM for use at boot-up, and DRAM for program and data storage for use while executing programs.

In embodiments, the memory 720 is non-transitory. In one embodiment where the network device is used to create the neural network described herein, memory 720 may include a training engine 720A, a pruning engine 720B, a super positioning engine 720C, training data 720D, one or more of sub-networks 720E, and a task execution engine 720 F.

The training engine 720A includes code which may be executed by the CPU 710 to perform neural network training as described herein. The pruning engine 720B includes code which may be executed by the CPU to execute network pruning as described herein. The super positioning engine 720 C includes code which may be executed by the CPU to execute super positioning of network nodes having weights as described herein. Training data 720D may include training data for existing tasks or new tasks which may be utilized by the CPU and the training engine 720A to perform neural network training as described herein. Sub-network 720E may include code which may be executable by the CPU to run and instantiate each of the pre-trained or other subnetworks described herein. Task execution engine 720F may include code executable by the processor to present the task to the large neural network as described herein in order to obtain a result.

The mass storage device 730 may comprise any type of storage device configured to store data, programs, and other information and to make the data, programs, and other information accessible via the bus 770. The mass storage device 730 may comprise, for example, one or more of a solid-state drive, hard disk drive, a magnetic disk drive, an optical disk drive, or the like. The mass storage device 730 may include training data as well as executable code which may be transmitted to memory 720 to implement any of the particular engines or data described herein.

The mass storage device may also store the any of the components described as being in or illustrated in memory 720 to be read by the CPU and executed in memory 720. The mass storage device may include the executable code in nonvolatile form for each of the components illustrated in memory 720. The mass storage device 730 may comprise computer-readable non-transitory media which includes all types of computer readable media, including magnetic storage media, optical storage media, and solid-state storage media and specifically excludes signals. It should be understood that the software can be installed in and sold with the network device. Alternatively the software can be obtained and loaded into network_device, including obtaining the software via a disc medium or from any manner of network or distribution system, including, for example, from a server owned by the software creator or from a server not owned but used by the software creator. The software can be stored on a server for distribution over the Internet, for example.

The network device 700 also includes one or more network interfaces 750, which may comprise wired links, such as an Ethernet cable or the like, and/or wireless links to access nodes or one or more networks 780. The network interface 750 allows the network device 700 to communicate with remote units via the networks 780. For example, the network interface 750 may provide wireless communication via one or more transmitters/transmit antennas and one or more receivers/receive antennas. In an embodiment, the network device 700 is coupled to a local-area network or a wide-area network 780 for data processing and communications with remote devices, such as other processing units, the Internet, remote storage facilities, or the like.

The present technology provides a neural network of a large size, defined by a network designer, which reuses multiple pre-existing, pre-trained smaller neural networks to create the large neural network using multi-level superposition. The network can thereby provide equivalent performance to custom-trained larger neural networks with lower energy consumption and greater flexibility. The large neural network can be updated through continuous learning by training new sub-networks with new tasks by prune and add new sub-networks to the pre-trained subnetworks. Given a defined number of sub-networks, mediocre networks can be removed.

For purposes of this document, it should be noted that the dimensions of the various features depicted in the figures may not necessarily be drawn to scale.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

Although the present disclosure has been described with reference to specific features and embodiments thereof, it is evident that various modifications and combinations can be made thereto without departing from scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

The foregoing detailed description has been presented for purposes of illustration and description. It is not intended to be exhaustive or to limit the subject matter claimed herein to the precise form(s) disclosed. Many modifications and variations are possible in light of the above teachings. The described embodiments were chosen in order to best explain the principles of the disclosed technology and its practical application to thereby enable others skilled in the art to best utilize the technology in various embodiments and with various modifications as are suited to the particular use contemplated. It is intended that the scope be defined by the claims appended hereto.

What is claimed is:

1. A computer implemented method of training a neural network comprising a number nodes, comprising:
instantiating a first plurality of pre-trained neural sub-networks each having a first number of multi-dimensional nodes, at least some of the multi-dimensional nodes having non-zero weights;
up-scaling ones of the first plurality of pre-trained neural sub-networks to have a second, larger number of multi-dimensional nodes such that ones of the first plurality of pre-trained neural sub-networks have a sparse number of non-zero weights associated with the second, larger number of multi-dimensional nodes;
creating the neural network by superpositioning non-zero weights of the plurality of pre-trained neural sub-networks by representing the non-zero weights in multi-dimensional nodes of the neural network;
receiving data for a first task for computation by the neural network; and
executing the first task to generate a solution to the first task from the neural network.

2. The method of claim 1 wherein the creating the neural network further comprises:
creating a second plurality of neural sub-networks having the second, larger number of multi-dimensional nodes by superpositioning non-zero weights of the first plurality of neural sub-networks; and
creating the neural network having multi-dimensional nodes by superpositioning non-zero weights of the second plurality of neural sub-networks into nodes of the neural network.

3. The method of claim 1 including re-training the neural network for a new task by replacing at least a subset of the first plurality of neural sub-networks for the new task.

4. The method of claim 3 wherein the re-training further includes re-training the neural network for the new task by:
calculating correlation parameters between the trained first plurality of neural sub-networks;
predicting an empirical distribution of labels in training data of a new task based on the first task;
training each of the first plurality of networks with the training data of the new task; and
replacing ones of the first plurality of neural sub-networks with re-trained neural sub-networks.

5. The method of claim 3 wherein the replacing comprises replacing ones of the first plurality of neural sub-networks when there are more than a maximum number of pre-trained neural sub-networks.

6. The method of claim 3 wherein the replacing comprises replacing neural sub-networks having mediocre performance as determined relative to training data for the new task.

7. The method of claim 1 wherein the method includes connecting each of the first plurality of neural sub-networks such that each of the first plurality of pre-trained neural sub-networks is connected to selective nodes of another of the first plurality of networks, the selective nodes being less than all of the plurality of nodes of the another of the first plurality of networks arranged in a first level of neural sub-networks comprising a sub-set of the first plurality of sub-networks.

8. The method of claim 7 wherein the method further includes connecting each of the sub-set of the first plurality of neural sub-networks in the first level to selective ones of nodes of the second plurality of neural sub-networks a second level of neural sub-networks comprising a sub-set of the first level.

9. A processing device, comprising
a non-transitory memory storage comprising instructions; and
one or more processors in communication with the memory, wherein the one or more processors create a neural network by executing the instructions to:
instantiate at least a first plurality of pre-trained neural sub-networks, each having a first number of multi-dimensional nodes, at least some of the multi-dimensional nodes having non-zero weights;
up-scale each of the first plurality of pre-trained neural sub-networks to have a second, larger number of multi-dimensional nodes such that ones of the first plurality of pre-trained neural sub-networks have a sparse number of non-zero weights associated with the second, larger number of multi-dimensional nodes; and
create the neural network by superpositioning non-zero weights of the first plurality of neural sub-networks by representing the non-zero weights in multi-dimensional nodes of the neural network.

10. The processing device of claim 9 wherein the processors execute instructions to re-train the neural network for a new task by replacing at least a subset of the first plurality of neural sub-networks for the new task.

11. The processing device of claim 9 the re-training further includes re-training the neural network for the new task by executing instructions to:
calculate correlation parameters between the trained first plurality of neural sub-networks;
predict an empirical distribution of labels in training data of a new task based on the new task;
train each of the first plurality of networks with the training data of the new task; and
replace ones of the first plurality of neural sub-networks with re-trained neural sub-networks.

12. The processing device of claim 10 wherein the replacing comprises replacing ones of the first plurality of neural sub-networks when there are more than a maximum number of pre-trained neural sub-networks.

13. The processing device of claim 10 wherein the replacing at least a subset of the first plurality of neural sub-networks for the new task comprises replacing neural sub-networks having mediocre performance as determined relative to training data for the new task.

14. The processing device of claim 9 wherein the processors execute instructions to create a second plurality of neural sub-networks having a second, larger number of multi-dimensional nodes by superpositioning non-zero weights of the first plurality of neural sub-networks; and
connect each of the first plurality of neural sub-networks such that each of the first plurality and the second plurality of neural sub-networks is connected to selective nodes of another of the first plurality of neural sub-networks, the selective nodes being less than all of the nodes of the another of the plurality of neural sub-networks such that multiple ones of the plurality of neural sub-networks are arranged in a level of neural sub-networks, the connected selective ones creating at least two levels of recursive connections of the first plurality of neural sub-networks.

15. A non-transitory computer-readable medium storing computer instructions to train a neural network, that when executed by one or more processors, cause the one or more processors to perform the steps of:
training a plurality of neural sub-networks each having a first number of multi-dimensional nodes by
instantiating a first plurality of pre-trained neural sub-networks, each having a first number of multi-dimensional nodes, at least some of the multi-dimensional nodes having non-zero weights;
up-scaling ones of the first plurality of pre-trained neural sub-networks to have a second, larger number of multi-dimensional nodes such that each of the first plurality of pre-trained neural sub-networks have a sparse number of non-zero weights associated with the second, larger number of multi-dimensional nodes;
creating a second plurality of neural sub-networks having the second, larger number of multi-dimensional nodes by superpositioning non-zero weights of the first plurality of neural sub-networks in the second plurality of neural sub-networks;
up-scaling ones of the second plurality of neural sub-networks to have a third number of multi-dimensional nodes such that ones of the second plurality of sub-networks have a sparse number of non-zero weights associated with the third number of multi-dimensional nodes; and
creating the neural network by superpositioning non-zero weights in multi-dimensional nodes of the neural network ones of the third plurality of networks;
receiving data for a first task for computation by the neural network; and
computing the task data to generate a solution to the first task from the neural network.

16. The non-transitory computer-readable medium of claim 15 wherein the processors execute instructions to re-train the neural network for a new task by replacing at least a subset of the first plurality of neural sub-networks for the new task.

17. The non-transitory computer-readable medium of claim 15 wherein the re-training further includes re-training the neural network for the new task by executing instructions to:
calculate correlation parameters between the trained first plurality of neural sub-networks;
predict an empirical distribution of labels in training data of a new task based on the first task;
train each of the first plurality of networks with the training data of the new task; and
replace ones of the first plurality of neural sub-networks with re-trained neural sub-networks.

18. The non-transitory computer-readable medium of claim 16 wherein the replacing comprises replacing ones of the first plurality of neural sub-networks when there are more than a maximum number of pre-trained neural sub-networks.

19. The non-transitory computer-readable medium of claim 16 wherein the replacing comprises replacing neural sub-networks having mediocre performance as determined relative to training data for the new task.

20. The non-transitory computer-readable medium of claim 16 wherein the one or more processors to perform the steps of: connecting each of the first plurality of neural sub-networks such that each of the first plurality and the second plurality of neural sub-networks is connected to selective nodes of another of the first and second plurality of neural sub-networks, the selective nodes being less than all of the nodes of the first and second plurality of networks, such that multiple ones of the first and second plurality of neural sub-networks are arranged in a level of neural sub-networks, the connecting creating at least two levels of recursive connections of the first and second plurality of neural sub-networks.
